(19) United States
(12) Patent Application Publication
(10) Pub. No.: US 2015/0142552 A1
(43) Pub. Date: May 21, 2015

(54) Sending Information Associated with a Targeted Advertisement to a Mobile Device Based on Viewer Reaction to the Targeted Advertisement

(71) Applicant: AT&T Intellectual Property I, L.P., Atlanta, GA (US)

(72) Inventors: Ian C. Schmehl, Allen, TX (US); James L. Cansler, JR., Rockwall, TX (US); Scott White, Austin, TX (US)

(73) Assignee: AT&T Intellectual Property I, L.P., Atlanta, GA (US)

(21) Appl. No.: 14/086,499

(22) Filed: Nov. 21, 2013

(51) Int. Cl. G06Q 30/02; G06K 9/00

(52) U.S. Cl. CPC G06Q 30/0269; G06Q 30/0255; G06K 9/00302; G06Q 30/0242; G06Q 30/0261; G06K 2009/4666
USPC 705/14.41; 705/14.66; 705/14.53

(57) ABSTRACT

A method includes detecting a signal strength of a signal of a mobile device. The method includes determining that the mobile device is in a vicinity of the device when the signal strength satisfies a threshold. The method includes sending an advertisement from the device to a display device in response to determining that the mobile device is in the vicinity of the device. The advertisement is selected based on a user profile associated with the mobile device. The method includes determining a reaction to the advertisement from a person associated with the mobile device. The method also includes sending information associated with the advertisement to the mobile device in response to a positive reaction from the person.

### FIELD OF THE DISCLOSURE

The present disclosure is generally related to sending information associated with targeted advertising to a mobile device based on viewer reaction to the targeted advertising.

### BACKGROUND

Advertisements targeted to groups of people may be selected based on a variety of factors including household demographics, geography, seasons, holidays, events, and time of day. For example, advertisers may present advertisements for children's toys in an area that is predicted to have a lot of young families and children, advertisements for winter jackets in an area that receives a lot of cold weather, and advertisements for take-out food at a time predicted to be before home cooks begin dinner preparation.

Targeted advertising selects an advertisement and sends the advertisement to select individuals instead of broadcasting the advertisement to a general broadcast population. The select individuals may be more responsive to the advertisement than the general broadcast population. Advertising distributors and providers that enable targeted advertising (e.g., internet portals, television providers, access network providers, etc.) can increase revenue per advertisement impression by providing targeted advertising options to service providers.

### BRIEF DESCRIPTION OF THE DRAWINGS

FIG. 1 is a block diagram of an embodiment of a system to send information associated with a targeted advertisement to a mobile device based on viewer reaction to the targeted advertisement.

FIG. 2 is a flow chart of an embodiment of a method to send information associated with a targeted advertisement to a mobile device based on viewer reaction to the targeted advertisement.

FIG. 3 is a block diagram of an illustrative embodiment of a general computer system.

### DETAILED DESCRIPTION

A mobile device may enter an area served by a device. For example, the mobile device may be carried by a person when the person walks into the area served by the device. The device may be a media device (e.g., a set-top box device or an advertising computer), a customer premises device, or another device that is able to send advertising to the mobile device. The device may also be able to send advertising to other devices (e.g., a television, an advertisement display, a computing device (e.g., a desktop computer, a laptop computer, a tablet computer, etc.) coupled to the device by a wired or wireless connection, etc.). The device may be located at a business establishment (e.g., a retail store), a domestic residence, or another location. The device may monitor signal strength of a signal sent by the mobile device. When the signal strength satisfies a threshold, the mobile device is considered to be in a vicinity of the device.

The device may receive identification information from the mobile device. The device may use the identification information to retrieve a user profile of a user associated with the mobile device. An advertisement may be sent from the device to a display device when the mobile device is in the vicinity of the device. The advertisement may be selected based on the user profile so that the advertisement is a targeted advertisement that may be of interest to the user. The display device may be a display screen of the mobile device, a monitor (e.g., a television, a computer monitor, etc.), an electronic advertising display, another type of display, or combinations thereof.

The device may receive response information associated with the advertisement. The response information may include data received at an input device, data from a camera system, data from a motion detector, data related to an analysis by the device that the mobile device remained in the vicinity of the device during display of the advertisement, other information, or combinations thereof. The device may determine whether a reaction by the person was a positive reaction based on the response information. For example, the device may determine a score associated with the advertisement based on data from the input device, the data from the camera system, other response information, or combinations thereof. When the score is above an interest threshold, the reaction by the person is considered to be a positive reaction.

When the reaction is a positive reaction, the device may send information associated with the advertisement to the mobile device. The information may be sent via a text message, an e-mail message, a pop-up display, a display of a web page, another type of message, or combinations thereof. The information may include an offer for a product or service associated with the advertisement, a phone number to contact a supplier of the product or service, a map that shows a location of where the product or service can be obtained (e.g., a location of a business associated with the advertisement), additional information about the product or service, or combinations thereof. Receipt of the information associated with the advertisement may facilitate purchase of the product or service by the person associated with the mobile device.

Supplying the advertisement to the person based on the user profile may promote purchase of a product or service associated with the advertisement since the advertisement may be directed to something of interest to the person associated with the mobile device. Further, supplying the information associated with the advertisement to the person may further promote purchase of the product or service by providing additional information associated with acquiring the product or service. Suppliers of the advertising may be able to charge a premium for supplying the advertisement to persons interested in the product or service and may be able to charge an additional fee for providing the information associated with the advertising. Suppliers of the product or service may be willing to the pay for targeted advertising and the supply of the information about the targeted advertising because of the increased likelihood of purchase of the product or service by a person who receives the targeted advertising, the information associated with the targeted advertising, or both.

In a particular embodiment, a method includes detecting, at a device, a signal strength of a signal of a mobile device. The method includes determining, at the device, that the mobile device is in a vicinity of the device when the signal strength satisfies a threshold. The method includes sending an advertisement from the device to a display device in response to determining that the mobile device is in the vicinity of the device. The advertisement is selected based on a user profile associated with the mobile device. The method includes determining, at the device, a reaction to the advertisement from a person associated with the mobile device. The method also includes sending information associated with the advertisement to the mobile device from the device in response to a positive reaction from the person.

In a particular embodiment, a system includes a processor and a memory coupled to the processor. The memory includes instructions executable by the processor to perform operations. The operations include determining that a mobile device is in a vicinity of the processor. The operations include sending an advertisement to a display device when the mobile device is in the vicinity of the processor. The advertisement is based on a user profile associated with the mobile device. The operations include determining a reaction to the advertisement by a person associated with the mobile device. The operations also include sending information associated with the advertisement to the mobile device in response to a positive reaction from the person.

In a particular embodiment, a computer-readable storage device includes instructions executable by a processor to perform operations. The operations include sending an advertisement to a display device upon detecting a mobile device in a vicinity of the processor. The advertisement is selected based on a user profile associated with the mobile device. The operations include determining a reaction to the advertisement by a person associated with the mobile device. The operations also include sending information associated with the advertisement to the mobile device in response to a positive reaction from the person.

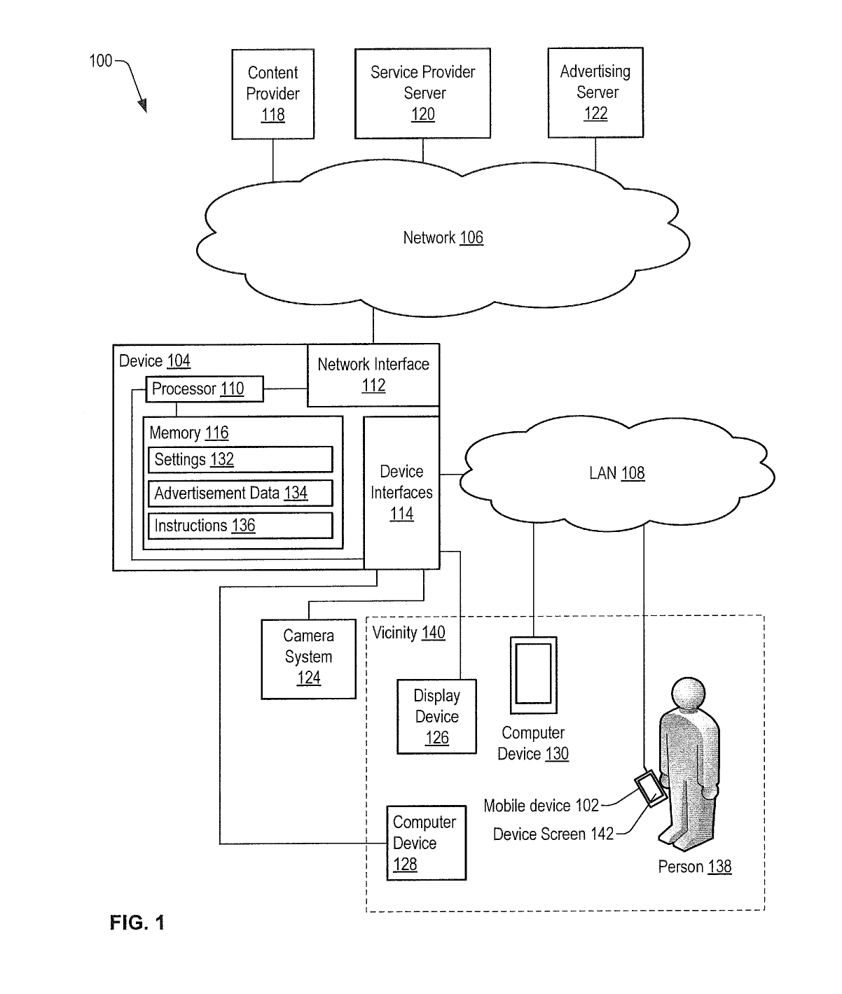

FIG. 1 is a block diagram of a particular embodiment of a system 100 to send information associated with a targeted advertisement to a mobile device 102 based on viewer reaction to the targeted advertisement. The mobile device 102 may be a mobile communication device, a laptop computer, a tablet computer, a personal digital assistant, another type of communication device, or a combination thereof. A device 104 may send the information associated with the targeted advertisement to the mobile device 102.

The device 104 may be located at a residence. The residence may be a commercial residence (e.g., a retail store) or a domestic residence (e.g., a house or an apartment). The device 104 may be, but is not limited to being, a set-top box device, an advertising computer, a server, a customer premises equipment (CPE) device, or combinations thereof. The CPE device may facilitate communications between a network 106 (e.g., the internet) and a local area network (LAN) 108 coupled to or established by the CPE device. The CPE device may include a router, a wireless router, a local area network device, a modem (e.g., a digital subscriber line (DSL) modem or a cable modem), a residential gateway, another communication device, or combinations thereof.

The device 104 may include a processor 110. The processor 110 may be coupled to a network interface 112, device interfaces 114, and a memory 116. The network interface 112 may enable the device 104 to communicate with other devices coupled to the device 104 via the network 106. The other devices may include, but are not limited to, a content provider 118, a service provider server 120, an advertising server 122, other servers, and combinations thereof.

The device interfaces 114 may enable wired or wireless connections of components and user devices to the device 104 and the LAN 108. The components may include, but are not limited to, a camera system 124, a display device 126, a computing device 128, a motion detector, another type of device, or combinations thereof. The user devices may include mobile devices (e.g., the mobile device 102), computing devices (e.g., a computer device 130, which may be a lap top computer, tablet computer, etc.), and other devices. In some embodiments, the device 104 may enable access to the network 106 via the network interface 112 to the components, the user devices, or both.

The memory 116 may store data, such as settings 132 and advertisement data 134. The settings 132 may include values for various options associated with the device 104. The values may be accessed and changed via one or more configuration interfaces. The advertising data 134 may store advertisements, pointers to advertisements, additional information associated with advertisements, other information associated with advertisements, or combinations thereof. The advertisements may be received from the advertising server 122 or from another source. The advertisement pointers may be uniform resource locators that include addresses of advertisements stored at the advertising server 122, at other sources, or both. The additional information associated with advertisements may include metadata about the content of the advertisements and data pertaining to suppliers associated with products or services presented by the advertisements. The data pertaining to suppliers may include contact information (e.g., phone numbers, location information, etc.), information about offers related to the products or services in the advertisements (e.g., information about discounts and time frames associated with the discounts), other information, or combinations thereof.

The memory 116 may also include instructions executable by the processor 110 to perform operations. The operations may enable the device 104 to present targeted advertising to a person 138 in a vicinity 140 of the device 104. The operations may also enable the device 104 to present information associated with targeted advertising to the person 138 when the person 138 has a positive reaction to the targeted advertising.

The device 104 may periodically or occasionally transmit beacon signals that request reply signals from electronic devices (e.g., from the mobile device 102 and the computer device 130) in range of the device 104. When the device 104 receives a reply signal from the mobile device 102, the device 104 may determine a signal strength of the reply signal. The device 104 may compare the signal strength to a signal strength threshold. When the signal strength threshold is satisfied, the mobile device 102 is considered to be in the vicinity 140 of the device 104. The signal strength may satisfy the threshold when the signal strength is greater than or equal to a particular value, or when the signal strength is between a first value and a second value (e.g., the vicinity is offset a distance from the device 104).

When the device 104 receives a reply to a beacon signal from the mobile device 102, the device 104 may determine whether the device 104 has received identification information from the mobile device 102. When the device 104 has not received identification information from the mobile device 102, the device 104 may send a request for identification information to the mobile device 102. The request may be a request for a media access control (MAC) address of the mobile device 102, a request for an identification number (e.g., a phone number) associated with the mobile device 102, a request for other identifiers associated with the mobile device 102, or combinations thereof. When the device 104 receives the identification information, the device 104 may use the identification information to request a user profile associated with the mobile device 102. The request for the user profile may be made to the mobile device 102, to the memory 116 of the device 104, to the service provider server 120, to the advertising server 122, to another server that provides user profiles, or to combinations thereof.

The device 104 may receive the user profile. The user profile may include, but is not limited to including, demographic information, user history data, user preferences, or combinations thereof for a user associated with the mobile device 102. The demographic information may include general information about the user, such as, but not limited to, name, age, sex, and residence information. The user history data may include information about the use of one or more devices associated with the user (e.g., the mobile device 102, the computer device 130, a set-top box device, a desk top computer, etc.). The information may include, but is not limited to, purchase information for items bought using the one or more devices, information about web sites visited by the user using the one or more devices, and information about viewing habits of the user via the one or more devices. The user preferences may include preference information directly input by the user via a preferences interface (e.g., likes and dislikes chosen from listings of subject categories) and preferences inferred from the user history data (e.g., the user is a fan of a particular hockey team because the user watches or records available hockey games of the particular team).

In some embodiments, the user profile may include an image or image data that may be used by the device 104 to determine that a person 138 that the device 104 associates with the mobile device 102 is the user identified in the user profile associated with the mobile device 102. In an embodiment, the device 104 may use facial characteristics and facial recognition instructions to determine whether the person 138 associated with the mobile device 102 is the same as the user associated with the user profile. When the person 138 is not the same as the user associated with the user profile, the device 104 may ignore the person 138 and the mobile device 102 and not provide a targeted advertisement. For example, a woman may borrow a male friend's mobile device (e.g., the mobile device 102) when her device is broken. When the woman is in a store, an advertising computer (e.g., the device 104) may communicate with the male friend's mobile device and retrieve a user profile associated with the male friend's mobile device. The camera system 124 coupled to the advertising computer may receive image data of the woman. The advertising computer may analyze the image data and data from the user profile. The advertising computer may determine that the woman is not the user associated with the male friend's mobile device. The advertising computer may then ignore the male friend's mobile device or the advertising computer may send a general advertisement instead of a targeted advertisement.

In a particular embodiment, the device 104 may analyze the user profile and select an advertisement that is likely to be of interest to the user from advertisements available to the device 104 by retrieving the advertisement data 134. In another embodiment, the device 104 may send particular data to the advertising server 122. The particular data may include the user profile, a portion of the user profile, information generated based on the user profile, or combinations thereof. A processor of the advertising server 122 may analyze the particular data and select a particular advertisement that may be of interest to the user. The advertising server 122 may send the advertisement to the device 104.

The selection of the advertisement by the device 104, or by the advertising server 122, may be made by comparing metadata associated with the advertisements to keywords associated with topics of interest to the user while eliminating from consideration advertisements that include topics that are disliked by the user. The device, or the advertising server, may generate an applicability score for available advertisements. The selected advertisement may be the advertisement with the highest applicability score. The selection of the advertisement may also be based on additional information. For example, the device may be located in a common area of a mall. The selection of the advertisement may be based on the location of the device relative to suppliers associated with advertised products or services that are of interest to the user based on the user profile.

The device 104 may send the advertisement selected by the device 104, or the advertisement received by the device 104 from the advertising server 122, to at least one display device when the mobile device 102 is in the vicinity 140 of the device 104. The at least one display device may be the display device 126 (e.g., a television, computer monitor, advertising monitor, etc.), a display screen of the computer device 130, a monitor of the computer device 128, a display screen 142 of the mobile device 102, or combinations thereof.

The device 104 may receive response information associated with the advertisement. The response information may include input from an input device (e.g., data from a computer device 130), data from the camera system 124 that monitors people in vicinity 140 (or a portion of the vicinity), data from a motion detector, analysis by the device 104 that the mobile device 102 remained in the vicinity 140 (or a portion of the vicinity) of the device 104 during display of the advertisement, other information, or combinations thereof. For example, the device 104 may receive response information as input from the computer device 128 that presents the advertisement at a computer monitor coupled to the computer device 128. The response information may include information that presentation of the advertising was cancelled before completion of the presentation. As another example, the camera system 124 coupled to the device 104, a camera system associated with the computing device 130 that receives the advertisement, or both, may send camera data to the device 104. Camera data from the camera system 124, the computing system 130, or both, may be analyzed to determine a focus location of the person 138 associated with the mobile device 102, movement of the person 138 associated with the mobile device 102, facial expressions of the person 138 associated with the mobile device 102, or combinations thereof.

Based on at least a portion of the response information, the device 104 may determine whether the person 138 had a positive reaction to the advertisement. For example, the determination may be that the person 138 had a positive reaction when the person 138 was focused on the advertisement and the person 138 smiled. As another example, the determination may be that the person 138 did not have a positive reaction when the person 138 left the vicinity 140 during presentation of the advertisement. In a particular embodiment, the device 104 may use the response information to calculate a score. The score may be compared to a response threshold to determine whether the reaction by the person 138 was a positive reaction. A high score may indicate a positive reaction to the advertisement (e.g., a score of 95 out of 100 determined based on the person 138 stopping in the vicinity 140 of the device 104, viewing the advertisement, and smiling during viewing the advertisement) and a low score may indicate that the reaction was not a positive reaction (e.g., a score of 2 out of 100 determined based on the person 138 moving out of the vicinity 140 of the device 104 during presentation of the advertisement while the focus of the person 138 was on the display device for less than 2 seconds).

When the device 104 determines that the reaction to the advertisement by the person 138 is positive, the device 104 may send information associated with the advertisement to the mobile device 102. The information may be sent via a text message, an e-mail message, a pop-up display, a display of a web page, another type of message, or combinations thereof. The message may include an offer for a product or service associated with the advertisement, a phone number to contact a supplier of the product or service, a map that shows a location where the product or service can be obtained, additional information about the product or service, or combinations thereof. The information may include information that is distinct from, and not included in, the advertisement. Receipt of the information associated with the advertisement may facilitate purchase of the product or service by the person 138 associated with the mobile device 102.

In some embodiments, the device 104 is located in a domestic residence. The device 104 may determine that the mobile device 102 is associated with the device 104. For example, the device 104 may be associated with a particular user and the mobile device 102 may be associated with the particular user, or the mobile device 102 may be detected in the presence of the device 104 more than a certain number of times in a time period (e.g., the mobile device 102 is considered to be associated with the device 104 when the mobile device 102 is detected by the device more than three separate times in a day). To avoid over application of targeted advertising to the particular user, the device 104 may ignore mobile devices associated with the device 104 or only periodically send targeted advertising based on the mobile device 102 being in the vicinity 140 of the device 102 (e.g., once every other day, once per week, once per month, or some other time period). Similarly, the device 104 may be an advertising computer in a retail store. The device 104 may detect the presence of one or more mobile devices that are often in the vicinity 140 of the device 104 and ignore such mobile devices (e.g., mobile devices associated with employees of the retail store).

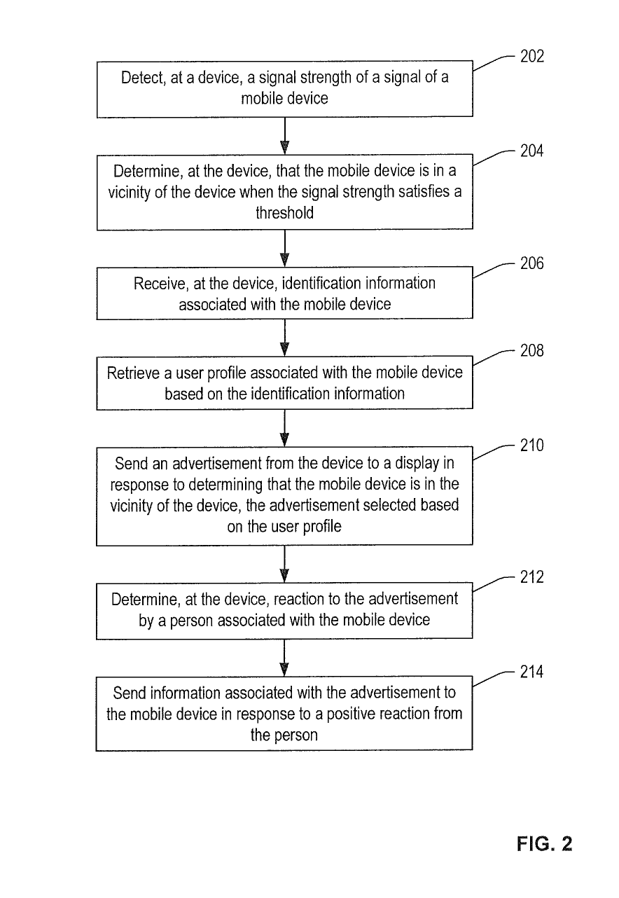

Referring to FIG. 2, a flow chart of a particular embodiment of a method to send information associated with a targeted advertisement to a mobile device based on viewer reaction to the targeted advertisement is disclosed. The method may be performed by a device, such as a set-top box device, an advertising computer, a customer premises equipment device, a server, or other type of device (e.g., the device 104 of FIG. 1). At 202, the device may detect a signal strength of a signal of a mobile device. The mobile device may be a mobile communication device, a laptop computer, a tablet computer, a personal digital assistant, another type of communication device, or a combination thereof.

The mobile device may send the signal in response to a beacon signal sent from the device. The device may compare the signal strength to a threshold. The device may determine that the mobile device is in a vicinity of the device when the signal strength satisfies the threshold, at 204.

When the device detects the mobile device, the device may request identification information from the mobile device. The device may receive the identification information from the mobile device, at 206. The identification information may include a media access control (MAC) address of the mobile device, an identification number associated with the mobile device (e.g., a phone number), another type of identifier, or combinations thereof.

The device may retrieve a user profile associated with the mobile device based on the identification information, at 208. The user profile may be retrieved from the device, from the mobile device, from a server of a service provider associated with the mobile device, from another server, from a database, from another device, or from combinations thereof. The user profile may include, but is not limited to, demographic information, user history data, user preferences, or combinations thereof, for a user associated with the mobile device.

An advertisement may be sent from the device to a display device in response to determining that the mobile device is in the vicinity of the device, where the advertisement is selected based on the user profile, at 210. In an embodiment, the device may select the advertisement from a plurality of available advertisements. In another embodiment, the device may send the user profile, selected information from the user profile, information determined based on the user profile, or combinations thereof, to an advertising server that selects the advertisement and sends the advertisement to the device. For example, the select information may include data that indicates that the user associated with the mobile device is male, eighteen to twenty five years old, is interested in electronics, basketball, soccer, fishing, and may be interested in purchasing a computer based on recent web browsing activity. In response, the advertising server may select a targeted advertisement for a computer system and may send the targeted advertising to the device.

The device may send the targeted advertisement to the display device. The display device may be a display screen of the mobile device, a monitor (e.g., the advertisement may be sent to a television as a commercial during a commercial break in scheduled programming), an advertising display coupled to the device (e.g., a monitor that displays advertising for available products in a retail store), a computing device (e.g., the advertisement may be sent to a computing device that accesses a local area network provided by the device via a browser program executing on the computer device when the mobile device is in the vicinity, and the advertisement may be a pop-up advertisement or a portion of a browser display), another type of display, or combinations thereof.

The device may determine a reaction to the advertisement by a person associated with the device, at 212. The device may receive response information associated with the advertisement. The response information may include input from an input device, data from a camera system, analysis by the device that the mobile device remained in the vicinity of the device during presentation of the advertisement, other information, or combinations thereof. The reaction may be quantified as a value based on the response information. For example, in an illustrative embodiment, the device calculates a reaction score based on the response information. A high score may indicate interest in the advertisement (e.g., a score of 75 out of 100 determined based on the person slowing forward movement through the vicinity and focusing on the display device while moving through the vicinity) and a low score may indicate little or no interest in the advertisement (e.g., a score of 25 out of 100 determined based on the person moving through the vicinity while only focusing on the display device for a first 10 seconds of a 30 second presentation).

The device may send information associated with the advertisement to the mobile device in response to a positive reaction from the person, at 214. Whether the reaction to the advertisement is positive may be determined by the device by comparing the score to an interest threshold. For example, when the score is greater than 40 out of 100 (i.e., the interest threshold is 40), the device may determine that the person exhibited a positive reaction. Other values for the interest threshold may be chosen instead of a value of 40 in other embodiments. The value for the interest threshold may be set by an advertiser, an advertisement provider, a service provider, another entity, or combinations thereof. In other embodiments, other indications may be used by the device to determine that the person exhibited a positive reaction. For example, the device may determine that a positive reaction by the person was exhibited when the mobile device remained in the vicinity during presentation of the advertisement and the advertisement was not terminated or ignored during the presentation of the advertisement, or when data from a camera system indicates that the person smiled while viewing the advertisement.

The information associated with the advertisement may be sent via a text message, an e-mail message, a pop-up display, a display of a web page, another type of message, or combinations thereof. The message may include an offer for a product or service associated with the advertisement, a phone number to contact a supplier of the product or service, a map that shows a location of where the product or service can be attained, additional information about the product or service, or combinations thereof. For example, when the advertisement is for a television in a retail store and the reaction to the advertisement was positive, the device (e.g., an advertising computer in a retail store) may send a text message to the mobile device that informs the person that the person may take 15% off the list price of a particular model (e.g., the model presented in the advertisement) by displaying the text message to a cashier during checkout. Receipt of the information associated with the advertisement may facilitate purchase of the product or service by the person associated with the mobile device.

Various embodiments disclosed herein describe a device that enables a targeted advertisement based on a user profile to be sent to a person associated with a mobile device when the mobile device is in a vicinity of the device. The device may also send information associated with the targeted advertisement to the mobile device when the person has a positive reaction to the targeted advertisement. Supplying the advertisement to the person based on the user profile may promote purchase of a product or service associated with the advertisement since the advertisement may be directed to something of interest to the person associated with the mobile device. Further, supplying the information associated with the advertisement to the person may further promote purchase of the product or service by providing additional information associated with acquiring the product or service.

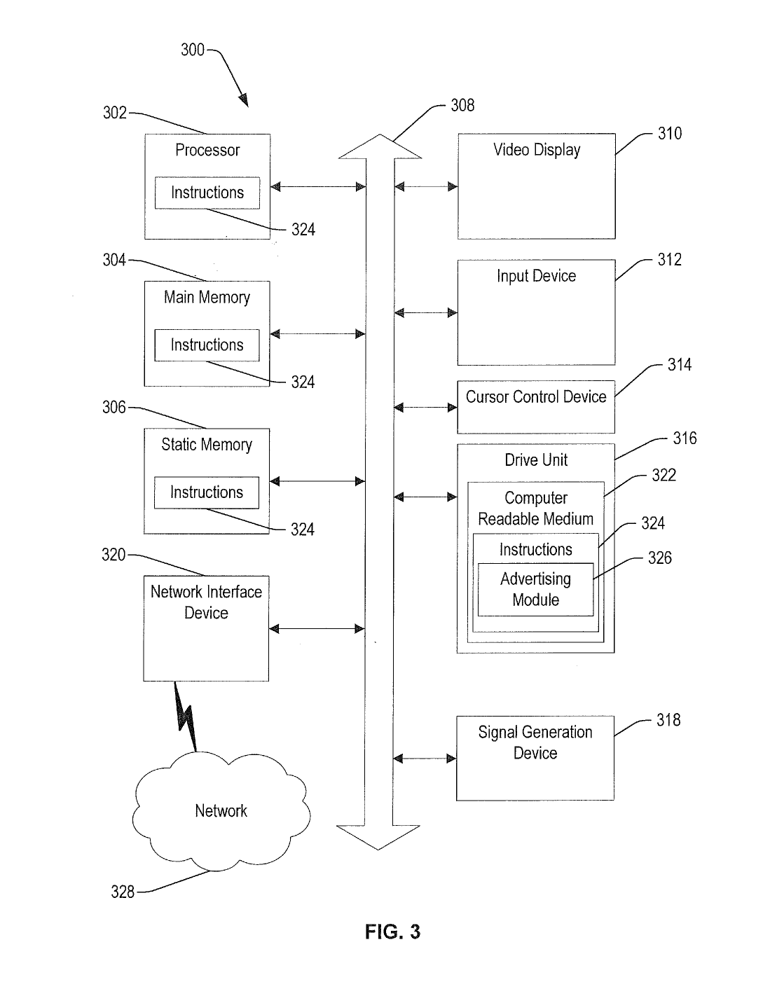

Referring to FIG. 3, an illustrative embodiment of a general computer system is shown and is designated 300. The computer system 300 may include a set of instructions that can be executed to cause the computer system 300 to perform any one or more of the methods or computer based functions disclosed herein. The computer system 300 may operate as a standalone device or may be connected, e.g., using a network, to other computer systems or peripheral devices. For example, the computer system 300 may include or be included within any one or more of the mobile device 102, the device 104, the content provider 118, the service provider server 120, the advertising server 122, the camera system 124, the display device 126, the computer device 128, or combinations thereof described with reference to FIG. 1.

In a networked deployment, the computer system 300 may operate in the capacity of a server or as a client user computer in a server-client user network environment, or as a peer computer system in a peer-to-peer (or distributed) network environment. The computer system 300 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a web appliance, or any other machine capable of executing a set of instructions (sequential or otherwise) that specify actions to be taken by that machine. In a particular embodiment, the computer system 300 may be implemented using electronic devices that provide video, audio, or data communication. Further, while a single computer system 300 is illustrated, the term “system” shall also be taken to include any collection of systems or sub-systems that individually or jointly execute a set, or multiple sets, of instructions to perform one or more computer functions.

As illustrated in FIG. 3, the computer system 300 may include a processor 302, e.g., a central processing unit (CPU), a graphics processing unit (GPU), or both. Moreover, the computer system 300 may include a main memory 304 and a static memory 306, which can communicate with each other via a bus 308. As shown, the computer system 300 may further include a video display unit 310, such as a liquid crystal display (LCD), a flat panel display, a solid state display, or a lamp assembly of a projection system. Additionally, the computer system 300 may include an input device 312, such as a keyboard, and a cursor control device 314, such as a mouse. The computer system 300 may also include a drive unit 316, a signal generation device 318, such as a speaker or remote control, and a network interface device 320. Some computer systems 300 may not include an input device (e.g., a server may not include an input device).

In a particular embodiment, as depicted in FIG. 3, the drive unit 316 may include a computer-readable storage device 322 in which one or more sets of instructions 324, e.g. software, can be embedded. As used herein the term “computer-readable storage device” refers to an article and excludes signals per se. Further, the instructions 324 may embody one or more of the methods or logic as described herein. In a particular embodiment, the instructions 324 may reside completely, or at least partially, within the main memory 304, the static memory 306, and/or within the processor 302 during execution by the computer system 300. The main memory 304 and the processor 302 also may include computer-readable storage devices. The instructions 324 in the drive unit 316, the main memory 304, the static memory 306, the processor 302, or combinations thereof may include an advertising module 326 to provide a targeted advertisement to a person in a vicinity of the computer system 300 based on a user profile and to provide information associated with the targeted advertisement to a mobile device associated with the person when the computer system 300 determines that a reaction to the targeted advertisement is a positive reaction.

In an alternative embodiment, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations may include distributed processing, component/object distributed processing, and parallel processing. Alternatively, virtual computer system processing may be constructed to implement one or more of the methods or functionality as described herein.

The present disclosure includes a computer-readable storage device 322 (e.g., a storage device) that stores instructions 324 or receives, stores and executes instructions 324, so that a device connected to a network 328 may communicate voice, video or data over the network 328. While the computer-readable storage device is shown to be a single device, the term “computer-readable storage device” includes a single device or multiple devices, such as a centralized or distributed database, and/or associated caches and servers that store one or more sets of instructions. The term “computer-readable storage device” shall also include any device that is capable of storing a set of instructions for execution by a processor or that cause a computer system to perform any one or more of the methods or operations disclosed herein.

In a particular non-limiting, exemplary embodiment, the computer-readable storage device may include a solid-state memory such as a memory card or other package that houses one or more non-volatile read-only memories. Further, the computer-readable storage device may be a random access memory or other volatile re-writable memory. Additionally, the computer-readable storage device may include a magneto-optical or optical medium, such as a disk or tapes or other storage device. Accordingly, the disclosure is considered to include any one or more of a computer-readable storage device and other equivalents and successor devices, in which data or instructions may be stored.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, IEEE 802.x) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method comprising:
detecting, at a device, a signal strength of a signal of a mobile device;
determining, at the device, that the mobile device is in a vicinity of the device when the signal strength satisfies a threshold;
sending an advertisement from the device to a display device in response to determining that the mobile device is in the vicinity of the device, wherein the advertisement is selected based on a user profile associated with the mobile device;
determining, at the device, a reaction to the advertisement from a person associated with the mobile device; and
sending information associated with the advertisement to the mobile device from the device in response to a positive reaction from the person.

2. The method of claim 1, wherein sending the advertisement comprises:
receiving identification information from the mobile device;
retrieving the user profile based on the identification information; and
selecting the advertisement based on user data, preferences, purchase history, web page access history, or combinations thereof, retrieved from the user profile.

3. The method of claim 1, wherein determining the reaction includes detecting a facial expression of the person and detecting whether the person focuses on the display during presentation of the advertisement.

4. The method of claim 3, wherein the device determines that the reaction is positive in response to detecting that the facial expression indicates a smile while the person focuses on the display device.

5. The method of claim 1, wherein the display device is a display screen of the mobile device.

6. The method of claim 1, wherein the display device is a display screen of a computing system coupled to the device.

7. The method of claim 1, wherein the display device is a monitor associated with the device.

8. The method of claim 1, wherein the device comprises a customer premises equipment device at a retail establishment.

9. The method of claim 1, wherein the device comprises a customer premises equipment device at a domestic residence.

10. The method of claim 1, wherein the device comprises a set-top box device.

11. A system comprising:
a processor;
a memory coupled to the processor, the memory comprising instructions executable by the processor to perform operations including:
determining that a mobile device is in a vicinity of the processors;
sending an advertisement to a display device when the mobile device is in the vicinity of the processor, the advertisement based on a user profile associated with the mobile device;
determining a reaction to the advertisement by a person associated with the mobile device; and
sending information associated with the advertisement to the mobile device in response to a positive reaction from the person.

12. The system of claim 11, further comprising a camera system coupled to the processor, wherein the camera system monitors people in the vicinity of the processor, and wherein data received by the processor from the camera system is used in determining the reaction to the advertisement by the person.

13. The system of claim 12, wherein the data is analyzed to determine whether the person watched the advertisement, whether the person made facial expressions related to the advertisement, or both.

14. The system of claim 11, wherein the operations further include retrieving the user profile based on identification information received from the mobile device.

15. The system of claim 11, wherein an indication of the positive reaction to the advertisement from the person includes the mobile device remaining in the vicinity of the processor during presentation of the advertisement to the display device.

16. A computer-readable storage device comprising instructions executable by a processor to perform operations including:
sending an advertisement to a display device upon detecting a mobile device in a vicinity of the processor, wherein the advertisement is selected based on a user profile associated with the mobile device;
determining a reaction to the advertisement by a person associated with the mobile device; and
sending information associated with the advertisement to the mobile device in response to a positive reaction from the person.

17. The computer-readable storage device of claim 16, wherein the information comprises an offer to purchase a product or service associated with the advertisement.

18. The computer-readable storage device of claim 16, wherein the information comprises a location of a business associated with the advertisement.

19. The computer-readable storage device of claim 16, wherein the information comprises contact information associated with a product or service associated with the advertisement.

20. The computer-readable storage device of claim 16, wherein the operations further include determining that the reaction is not the positive reaction when the advertisement is a video and the video is interrupted before completion.
